(19) United States
(12) Patent Application Publication
(10) Pub. No.: US 2003/0041183 A1
(43) Pub. Date: Feb. 27, 2003

(54) Multimedia imaging and control apparatus

(75) Inventors: Richard C. LaPierre, Watertown, MA (US); Douglas Steinfeld, Marlborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Viewwriter Technologies, Waltham, MA

(21) Appl. No.: 10/171,092

(22) Filed: Jun. 12, 2002

Related U.S. Application Data
(60) Provisional application No. 60/297,690, filed on Jun. 12, 2001.

(51) Int. Cl. G06F 3/00

(52) U.S. Cl. 710/1

(57) ABSTRACT

In accordance with certain embodiments of the present invention, an apparatus can display a presentation to an audience while archiving the presentation for future use. This result can be achieved by using a multimedia hub having an optical platen with a first and a second surface, an internal imager positioned below the second surface of the optical platen to image indicia on the first surface of the optical platen, a converter for converting the image from the internal imager to a plurality of video formats, and a plurality of outputs ports connected to the converter, each output port providing a respective video format. The indicia can include any writing, whether printed on paper, transparency film, or printed directly on the first surface of the optical platen.

### RELATED APPLICATION

This application claims the benefit of U.S. Provisional Application No. 60/297,690, filed Jun. 12, 2001, the entire teachings of which are incorporated herein by reference.

### BACKGROUND

Multimedia presentations are becoming more prevalent in office meetings, teaching environments, and the like. Meeting rooms and lecture halls are equipped with multimedia devices that typically contain an overhead or video projector, a computer connected to the video projector, microphones, etc. The lighting in these rooms and halls is typically dimmed during the presentation to allow for easy viewing.

### SUMMARY

When the lights are dimmed light, the presenter does not have full command of the audience. Also, present multimedia systems do not allow for archiving presentations for future use.

In accordance with certain embodiments of the present invention, an apparatus can display a presentation to an audience while archiving the presentation for future use.

This result can be achieved by using a multimedia hub having an optical platen with a first and a second surface, an internal imager positioned below the second surface of the optical platen to image indicia on the first surface of the optical platen, a converter for converting the image from the internal imager to a plurality of video formats, and a plurality of outputs ports connected to the converter, each output port providing a respective video format. The indicia can include any writing, whether printed on paper, transparency film, or printed directly on the first surface of the optical platen.

The multimedia hub can also include an integrated monitor connected to the converter. A plurality of input ports can be connected to the converter for receiving image signals from a plurality of external input devices. The multimedia hub can allow a user to select an input signal from the plurality of the input ports. The plurality of inputs can include a FireWire™ port, an ethernet port, a composite video signal port, a S-video port, a RGB port, a universal serial bus (USB) port, a microphone port and an audio port. The plurality of outputs ports can include a FireWire™ port, an ethernet port, a composite video signal port, a S-video port, a RGB port, a universal serial bus (USB) port and an analog output port.

A controller can allow for an annotation mode which can overlay an image derived from an input port with a user annotation formed on the first surface of the optical platen. The controller can also allow a user to control the functions of the internal video imager. An archiving mode can be used to record the images sent though the multimedia hub on a recording device.

A mirror can be positioned between the optical platen and the internal imager to reverse the image recorded by the internal imager or the image recorded by the video imager is reversed by electronics contained with the multimedia hub.

### BRIEF DESCRIPTION OF THE DRAWINGS

The foregoing and other objects, features and advantages of the Multimedia Imaging and Control Apparatus will be apparent from the following more particular description of embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a multimedia presentation with associated presentation devices;

FIG. 2A shows a perspective view of one embodiment of the present invention;

FIG. 2B shows a perspective view of another embodiment of the present invention;

FIG. 3 is a perspective view of the optical platen;

FIG. 4 is a schematic view of one set of angles the internal camera can be set to allow recording of indicia located on the surface of the optical platen;

FIG. 5 is a schematic view of the video board;

FIG. 6 is a schematic view of the audio board;

FIG. 7 is a schematic view of the control board;

FIG. 8 is a users view of the control panel;

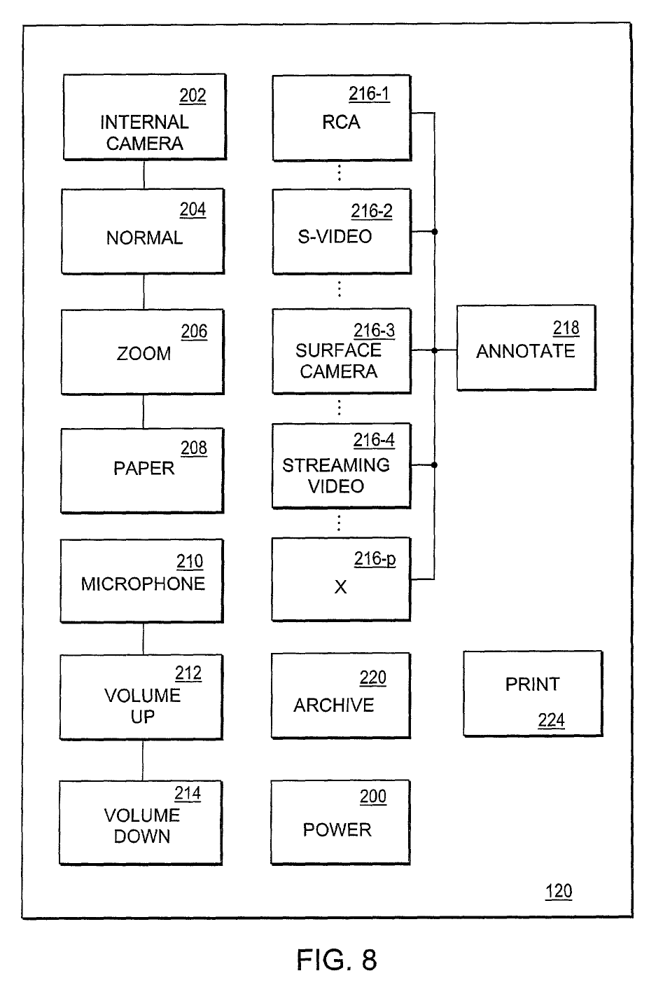

FIG. 9 is a flow chart of a stand-alone mode of the invention;

FIG. 10 is a flow chart of an external mode of the invention.

### DETAILED DESCRIPTION

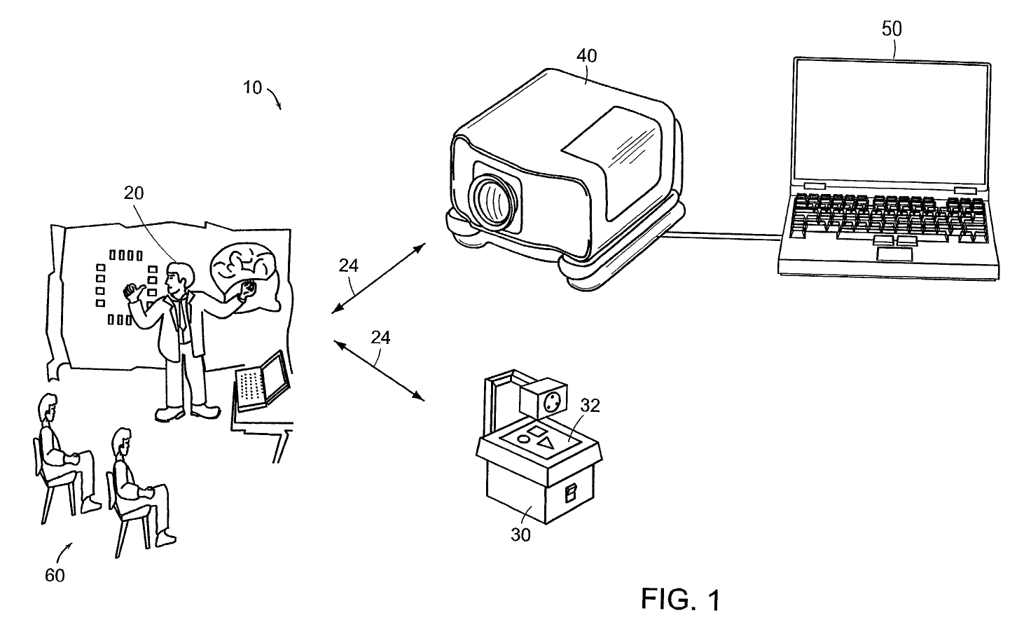

In general, as shown in FIG. 1, during prior art multimedia presentations 10 a presenter 20 can use a variety of presentation devices associated with the presentation. These devices can include an overhead projector 30, a video projector 40 coupled to a computer 50 or like devices, or a combination of these devices. The presenter 20 can use the overhead projector 30 to display transparencies to the audience 60. The presenter 20 can also annotate the transparencies or write directly on the overhead projector's face 32 using erasable markers. The computer 50 and video projector 40 can be used to display a computer software presentation. The present invention combines same functions of the prior art presentation devices and adds new functions into a single presentation device. The current version of the present invention is V-50 made by VIEWWRITER™ Technologies of Waltham, Mass.

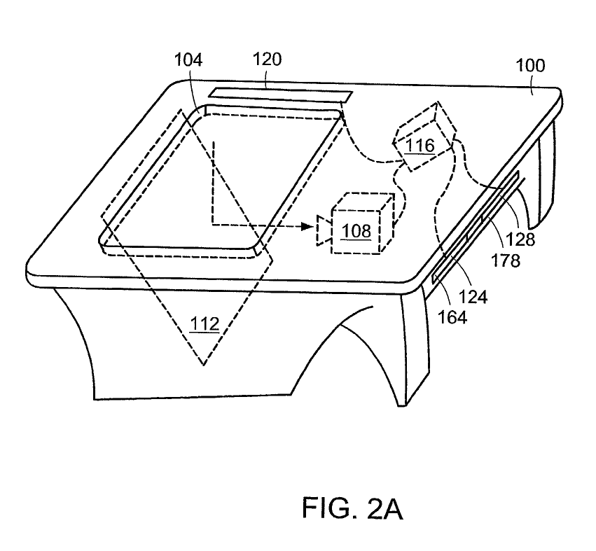

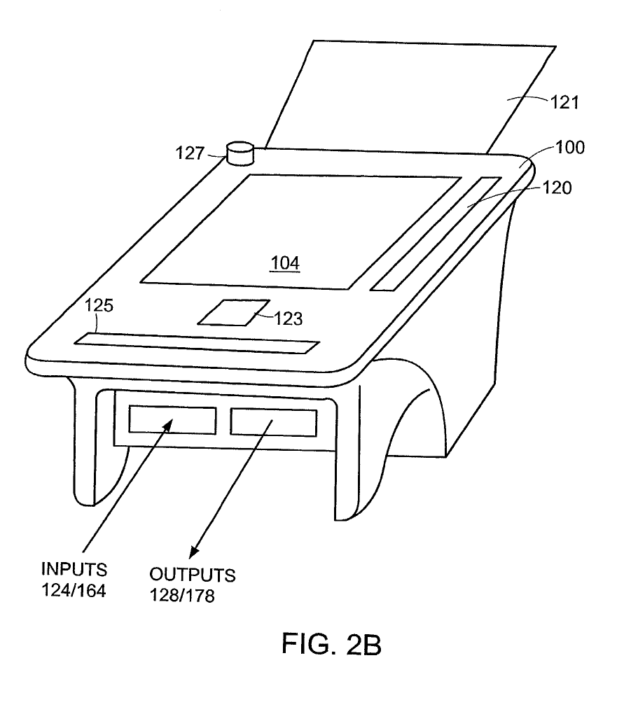

FIGS. 2A and 2B show embodiments of the present invention. The multimedia hub 100 contains an optical platen 104, internal camera 108, and reversing device 112 for reversing the image recorded by the internal camera 108. The multimedia hub 100 is configured so as to secure these devices 104, 108 and 112 in a fixed geometrical relationship to each other. The multimedia hub 100 also includes a function board 116. This configuration allows the presenter 20 to present documents and other material while adjusting the projected image. A control panel 120 is located on a surface of the multimedia hub 100 and is electrically connected to the function board 116 for controlling the operation of the multimedia hub 100. The control panel 120 can be a touch screen or like device located within close proximity to the presenter 20. Video input ports 124, audio input ports 164, video output ports 128, and audio output ports 178 are located on a surface on the multimedia hub 100 and are electrically connected to the function board 116 for receiving and transmitting signals to and from external devices, respectively. A detailed description of the basic internal components of the multimedia hub 100 can be found in U.S. Pat. No. 5,619,253, the entire teachings of which are incorporated herein by reference.

The multimedia hub 100 in FIG. 2B further includes a surface camera input port 127, an erasable marker holder 125, a video monitor 123, and a clear document protector (CDP) 121. The video monitor 123 can include a liquid crystal display (LCD) device, cathode ray tube (CRT) device or any other device capable of outputting a video signal. The video monitor 123 can be contained with the optical platen 104 or CDP 121. A LCD projector contained with the multimedia hub 100 can project the video output image onto the optical platen. The CDP 121 can also include the video monitor 123 and control panel 120. The CDP 121 can also provide various outputs in certain positions. In one position, the CDP 121 can provide a video image to the presentation viewers 60. In another position, the CDP 121 can provide a video image and touch screen control panel to the presenter 20. And yet in another position, the CDP 121 can protect a document on the optical platen 104 from being directly annotated thereon.

The multimedia hub 100 is fully operational under normal indoor lighting conditions. Accordingly, presenters 20 need not darken a room to permit usage of the multimedia hub 100. Further, the multimedia hub 100 permits the full area of the optical platen 102 to be projected onto one or more external devices at local or remote locations. Thus, written indicia or other materials can be projected without visual interference to assist the presenter 20 in making an oral presentation. The effect of these attributes can maximize the transfer of information between the presenter 20 and the viewing audience 60. More particularly, the multimedia hub 100 permits viewers of the information to maintain a high level of interest in the material being communicated throughout the entire presentation. However, in poor ambient lighting conditions an external light source can be coupled to the multimedia hub 100 to brighten the area over the optical platen 104.

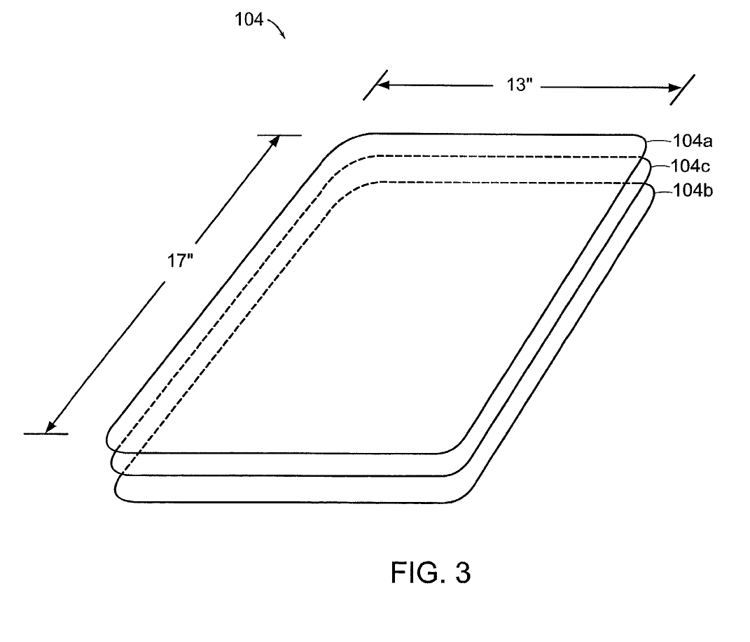

FIG. 3 shows an embodiment of the optical platen 104 of the present invention. In an embodiment, the optical platen 104 is made typically of a laminate material with lateral dimensions sized to accept virtually any size of document. In an embodiment, the optical platen 104 is approximately thirteen inches in width and seventeen inches in height. The optical platen 104 includes two clear glass plates 104a and 104b between which is positioned a sheet of polyvinyl butylate 104c. The glass plates 104a and 104b are generally each between about 0.1 inches and about 0.2 inches thick. The polyvinyl butylate sheet 104c is typically between about 0.020 inches and about 0.04 inches thick. The upper surface of the top glass plate 104a, i.e., the writing surface, can be flashed with an Opal coating familiar to those skilled in the art.

In another embodiment, the optical platen 104 can be made from a single sheet of tempered glass. The glass is typically laminated or tempered for safety reasons. The optical platen 104 can be made of any type of glass and need not be laminated, or tempered, so far as the glass has reasonable optical qualities. A particular optical platen 104 material is commercially available from Howard Glass of Worcester, Mass.

In an embodiment, the optical platen 104 is positioned within an appropriate rectangular opening of the multimedia hub I 00. A bezel structure holds the optical platen 104 in position in the rectangular opening. When fully assembled, the exposed surface, i.e., the writing surface 104a, of the optical platen 104 typically measures approximately twelve inches by sixteen inches.

The optical platen 104 generally accepts written indicia, transparencies, and type written material on ordinary translucent paper having a weight, so called, of up to twenty pounds. The multimedia hub 100 permits presenters 20 to annotate, amend, or erase these materials virtually without limitation. Further, the action undertaken by the presenter 20 does not block the image being viewed. The multimedia hub 100 immediately transmits the image to an external output device or devices for viewing.

The internal camera 108 includes a detector array element and a zoom lens element. The detector array element and zoom lens element are, typically, mounted with the multimedia hub 100 in close proximity, and in visual communication with, the lower surface 104b of the optical platen 104. The multimedia hub 100 includes other elements configured to facilitate the adjustment of the area viewed by the internal camera. Other elements can facilitate movement of the image being displayed on, for example, a television screen. More particularly, the multimedia hub 100 can include elements capable of adjusting the projected position of the image being viewed. Image adjustment of this type occurs along both the “X” and “Y” axis. Additional operational elements can facilitate magnification of, and localization on, selected portions of the image being viewed. In particular, the zoom element includes elements configured to adjust the overall dimensions of the image being produced as to fill the entire projection screen of the output device upon which the image being produced is projected. Usage of all these adjustment mechanisms in concert allows presenters 20 of the multimedia hub 100 to magnify, focus, combine, and compress a wide variety of materials that can be positioned on the optical platen 104.

The zoom feature of the internal camera 108 is factory aligned and typically requires no field adjustments in order to facilitate operation of the multimedia hub 100. However, an internal digital signal processor (DSP) located within the multimedia hub 100 can be used to optimally set the zoom feature automatically while the multimedia hub 100 is in operation. Therefore, the DSP can set the zoom feature to the exact paper size for better resolution.

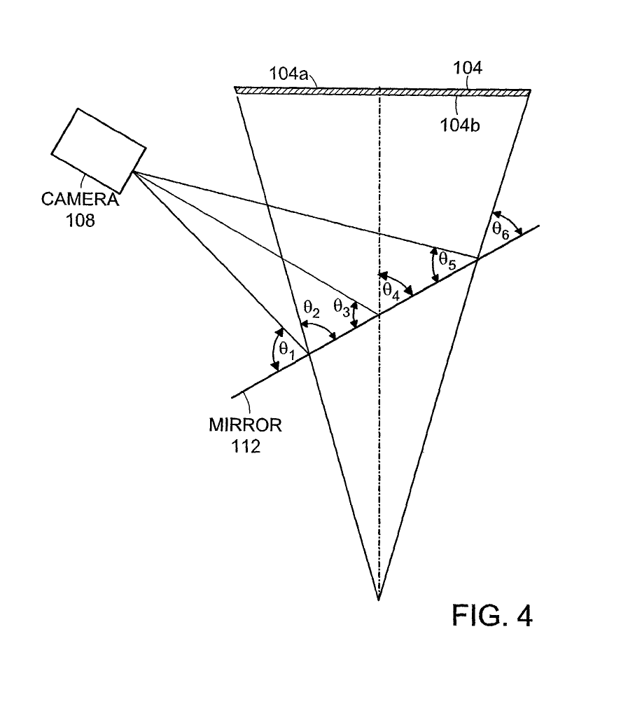

A reversing device for reversing the image being viewed by the internal camera 108 can be a single mirror 112. The mirror 112 is typically between 0.1 and 0.2 inches thick. The front surface of the mirror 112 is typically coated with aluminum and a silicon monoxide protective overcoat familiar to those skilled in the art. The reversing device for reversing the image being viewed by the internal camera 108 is mounted at an appropriate location, and angle (θ), relative to the optical platen 104 and internal camera 108 as shown in FIG. 4. For optimal imaging, the internal camera 108 can be positioned relative to the mirror 112 and optical platen 104 such that the reflective angle associated with the camera lens and viewing surface of the optical platen are the same. As shown in FIG. 4, θ₁=θ₂, θ₃=θ₄, and θ₅=θ₆, wherein θ₁ and θ₂ is an angle relative to a proximate end of the optical platen 104, θ₃ and θ₄ is an angle relative to the center of the optical platen 104, and θ₅ and θ₆ is an angle relative to a distal end of the optical platen 104. In particular, the reversing device is positioned so as to accommodate the requisite principle ray distance in object space of the internal camera lens. The mirror 112 is generally mounted on a thin, typically 10-mil, gasket material. The mirror 112 typically has a trapezoidal configuration. Alternatively, the image revising device can be an odd number of mirrors or an even number of mirrors, where zero is even, electronically reversed on the function board 120 by a DSP.

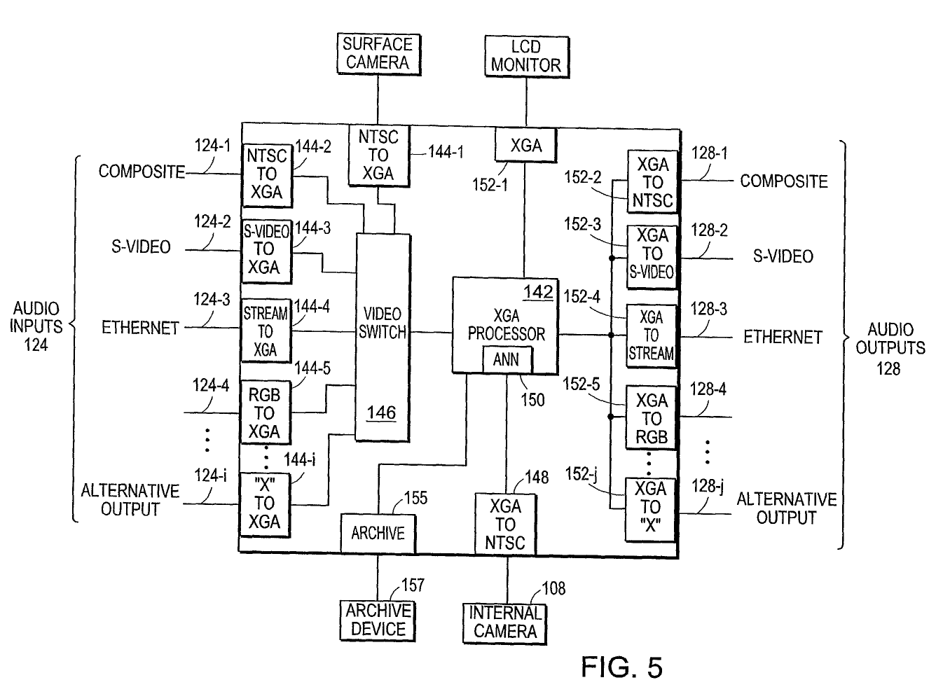

The multimedia hub 100 contains a function board 116 to control the internal and external features of the multimedia hub 100. The function board 116 contains a video board 140, an audio board 160 and a control board 180. As shown in FIG. 5, the video board 140 accepts a plurality of video input ports 124-1,. . . , 124-i and provides a plurality of video output ports 128-1, . . . , 128-j. The video input ports 124 can include, but are not limited to a surface camera port, a FireWire™ port, an ethernet port, a composite video signal port, an S-video port, a universal serial bus (USB) port, a wireless port, a RGB port, or any other alternative input port capable of accepting a video signal. The video input devices can include any compatible device associated with an input port 124, e.g., a surface camera, a streaming video device, a computer, a computer network, a video cassette recorder (VCR), a compact disc (CD) recorder, or a digital video disc (DVD) player, etc.

The video signals inputted to video board 140 are converted 144-1, . . . , 144-i to the base format of the video processor 142. The format of the video processor 142 can be any format that is convenient to use, i.e., eXtended Graphics Array (XGA) format. The converted video signals 144-1, . . . , 144-i are fed to a video switch 146 that allows the presenter 20 to choose from the inputs 124-1, . . . , 124-i for displaying on the output devices. The internal camera 108 signal also gets converted 148 to the format of the video processor 142. An annotator 150 is provided to annotate the image that is currently being processed by the video processor 142. The process of invoking the annotator 150 will be explained below.

The video processor 142 outputs it current format to the output ports 128-1, . . . , 128-j. The video signals outputted from the video processor 142 are converted 152-1, . . . , 152-j to the format of the associated with the video output port 128. The video output ports 128 can include, but are not limited to a liquid crystal display (LCD) port, a FireWire™ port, an ethernet port, a composite video signal port, an S-video port, a universal serial bus (USB) port, a wireless port, a RGB port, or any other alternative input port capable of outputting a video signal. The video output devices can include any device compatible with an output port 128, e.g., a LCD monitor, a streaming video device, devices, a monitor/television, a computer, a computer network, a video cassette recorder (VCR), a compact disc (CD) recorder, or a DVD recorder. It should be understood that any device capable of receiving a National Television Standards Committee (NTSC) signal, Phase Alternate Line (PAL) signal, or other standard protocols, can be used as an output device and multiple devices can be used as an output device. The video processor 142 can also send a video output 155 to an archiving port 155 for recording the presentation on an internal archiving device 157. The archiving device 157 can be an internal hard drive, internal CD recorder or like device.

A video streaming device can be connected to the ethernet ports of the multimedia hub 100 for video streaming of the presentation. A video streaming device is commercially available through VBrick Systems, Inc. of Wallingford, Conn.

The video streaming device and multimedia hub 100 combine to stream “real-time/full motion” video and audio over networks to personal computers (PCs) running viewing software, i.e., StreamPlayerII™ by VBrick Systems. The video streaming device should support industry standard IP Multicast for streaming video to any number of PCs in a company, enterprise, school, hospital, etc. The video streaming device uses video compression and network protocol standards such as MPEG-1, MPEG-2, IP, DiffServ, RTP, and can be viewed anywhere at any time. The video streaming device and multimedia hub 100 can be used for interactive video conferencing.

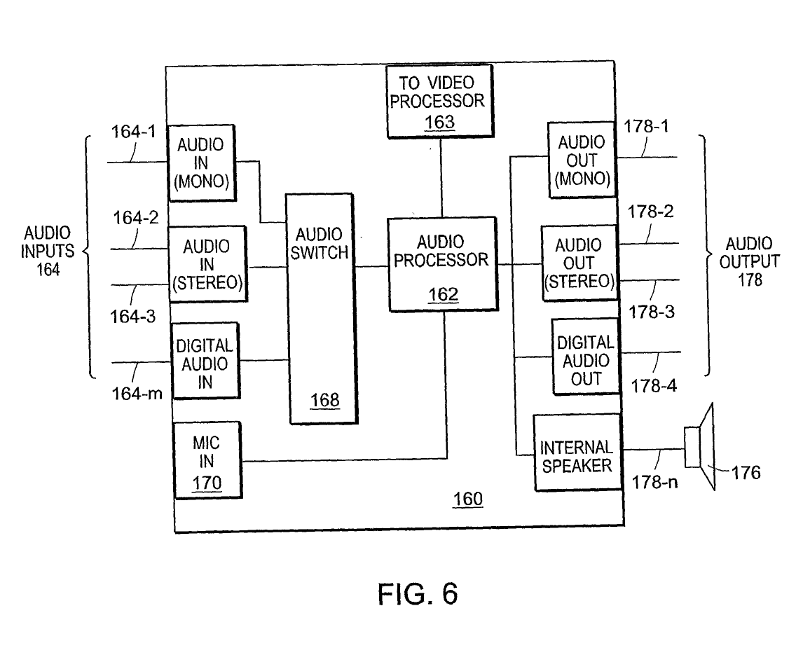

As shown in FIG. 6, the audio board 160 accepts a plurality of audio input ports 164-1, . . . , 164-m and provides a plurality of audio output ports 178-1, . . . , 178-n. The audio input ports 164 can include, but are not limited to a microphone port, a mono audio port, a stereo audio port, a digital audio port, or any other alternative audio input port capable of accepting an audio signal. The audio input devices can include any device compatible with an audio input port 164, e.g., a microphone.

The audio signals 164-1, . . . , 164-m are sent to an audio switch 168 that works in conjunction with the video switch 146 to allow the presenter 20 to choose from the audio input ports 164 associated with its video input ports 124. The microphone port 170 is sent directly to the audio processor 162 for further processing.

The audio processor 162 provides outputs to the audio output ports 178‘, . . . , 178-n. The audio processor 162 also outputs an audio signal 163 to the video processor 142 for mixing the video and audio signals together to output devices which accept a dual format. The audio output ports 178-1, . . . , 178-n can include, but are not limited to a speaker port, a mono audio port, a stereo audio port, a digital audio port or any other alternative audio input port capable of accepting an audio signal. The audio output devices can include any device compatible with an audio output port 178, e.g., a internal speaker 176, a Public Address (PA) system, etc.

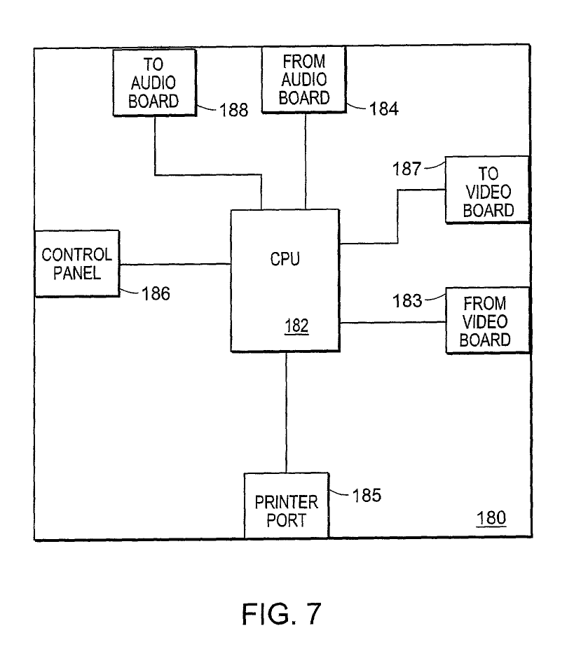

As shown in FIG. 7, a central processing unit (CPU) 182 on the control board 180 receives signals 183, 184, 186 from the video board 140, audio board 160, and control panel 120, respectively. The control panel can contain a printer port 185 for printing a “snap shot” of the presentation on a printing device. The CPU 182 can be programmable for future upgrades of the multimedia hub 100. The control board 180 also sends control signals 187, 188 to the video board 140 and audio board 160, respectively, associated with functions received from the control panel 120.

The control panel 120 contains various keys for controlling various features of the multimedia hub 100. A power key 200 can turn the multimedia hub 100 on or off. An internal camera key 200 can turn the internal camera 108 on. During this state, written indicia, transparencies, and type written material on ordinary translucent paper located on the optical platen will be displayed on the video output devices 128. Also, direct annotation can be made to the surface of the optical platen 104 without depressing the annotation key 218.

While in internal camera mode, a normal key 204, a zoom key 206 and a paper key 208 can function. In normal mode, the entire optical platen 104 surface is displayed full screen on the video output devices 128. The zoom key 206 magnifies the size of the display seen on the video output devices 128. This is most useful when using a 8½″×11″ sheet of paper or transparencies on the optical platen 104. The normal key 204 is used to return back to normal view from zoom mode. The paper key 208 is used to allow single sided, preprinted paper on the optical platen 104. The paper key 208 brightens the displayed image by changing the F-stop on the internal camera 108 by 1.5 times and the video processor 142 enhances the color of the image. Alternatively, a DSP can be used to identify different components of the indicia and remove unessential aspects from the image. The presenter 20 should experiment with the paper to be used under the same lighting conditions as will be present during the actual presentations to see whether paper mode or normal mode provides the best display. The paper key 208 functions as a toggle switch that each time pressed, the presenter 20 goes from normal mode to paper mode and back again.

A microphone key 210 can turn the microphone input port on or off. The presenter 20 can control the microphone volume using volume up key 212 and volume down key 214. The volume level on the audio output device can be adjusted prior to use to provide the best range of volume control for the particular circumstances. The multimedia hub 100 works as a pre-amplifier, controlling the line audio level signal out, which is fed into the audio output devices.

The external input device keys 216-1, . . . , 216-p allows the multimedia hub 100 to switch between any of the video inputs 124-1, . . . , 124-i and associated audio inputs 164-1, . . . 164-m and the internal camera 108. An external input device can be connected to the multimedia hub 100 through the plurality of video input ports 124-1, . . . , 124-i. However, the video input may not contain the audio feed associated with the video feed as is the case with a S-video input. In this case, when the S-video key is pressed both the video feed and audio feed are combined and feed to the output device or devices. It should be understood that there will be a one-to-one correlation between the external input device keys 216 and the amount of video input ports 124 and audio input ports 164 on the multimedia hub 100.

An annotation key 218 allows a presenter 20 to annotate the image from one of the external video devices using the optical platen 104. When the annotation key 218 is pressed and video monitor can be turned on to help the presenter 20 annotate the image. The annotation mode works in real-time, therefore the audience 60 will see the original image sent from the video input device being annotated by the presenter 20. An archive key 220 can allow the presenter to archive the presentation on an internal storage medium, such as an internal hard drive, CD recording device or the like. The presentation also can be recorded on an output device having recording capabilities such as a CD recorder or the like device. A print key 224 can be used to print the current image being displayed on the output device.

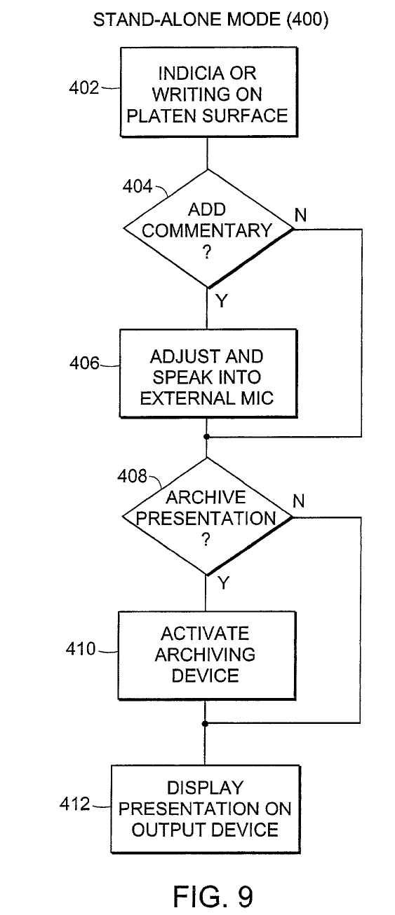

The multimedia hub 100 can be used in two modes of operation. As shown in FIG. 9, the first mode is standalone mode 400 and comprises the following steps:

(402) Step 1: A presenter 20 either places indicia or writes directly on the surface of the optical platen 104. The internal camera 108 records the indica or writing into an associated image.

(404) Step 2: Determine whether or not commentary from the presenter 20 will be added to the presentation electronically. The presenter 20 can add commentary to the associated image or heard over an internal speaker or external PA system. If no commentary is desired go to step 4 (408).

(406) Step 3: The presenter 20 adjusts and speaks into an external microphone connected to the multimedia hub 100.

(408) Step 4: Determine if the presentation will be internally archived for future use. The presenter 20 can archive the presentation on an internal recording device, such as a hard disc, CD recorder or like device. Alternatively, the presenter 20 can record the presentation on an output device of step 6 (412) provided the output device allows for such recording. If archiving is not desired go to step 6 (412).

(410) Step 5: The presenter 20 presses the archiving key 220 on the control panel 120. The internal archiving device is activated and records the presentation. Further pressing of archive key 220 toggles the recording function on and off.

(412) Step 6: The presentation is displayed on an output device or devices. It should be understood that step 2 (404) and step 4 (408) can be invoked or revoked at any time during the presentation.

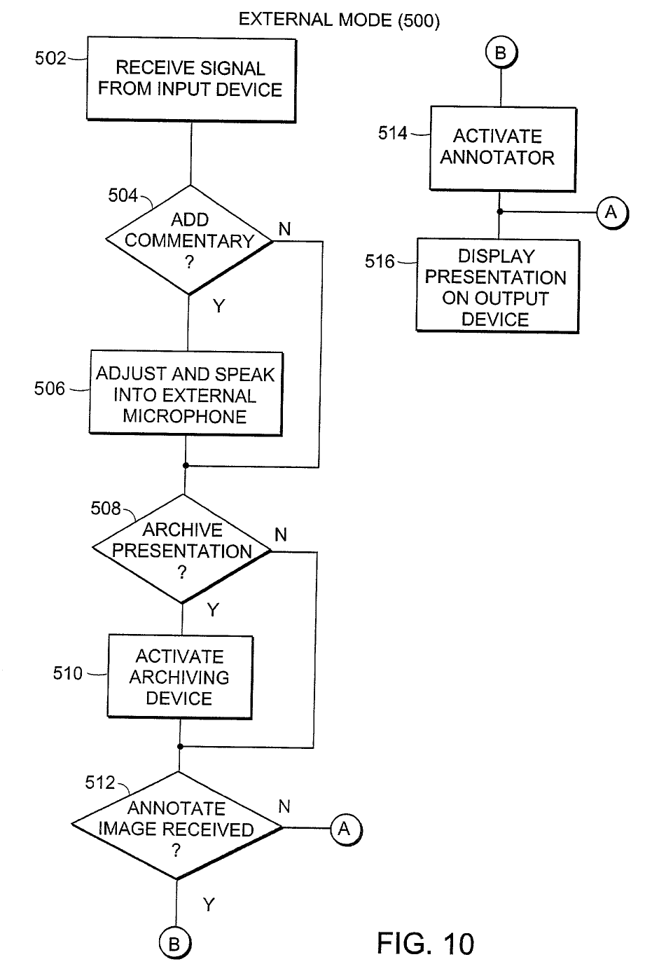

As shown in FIG. 10, the second mode is an external mode 500 and comprises the following steps:

(502) Step 1: An signal is received by the multimedia hub 100 from and external input device. The signal contains at least an image for the presentation and may also contain an associated audio feed.

(504) Step 2: Determine whether or not commentary from the presenter 20 will be added to the presentation electronically. The presenter 20 can add commentary to the associated external signal or be heard over an internal speaker or external PA system. If no commentary is desired go to step 4 (508).

(506) Step 3: The presenter 20 adjusts and speaks into an external microphone connected to the multimedia hub 100.

(508) Step 4: Determine if the presentation will be internally archived for future use. The presenter 20 can archive the presentation on an internal recording device, such as a hard disc, CD recorder or like device. Alternatively, the presenter 20 can record the presentation on an output device of step 8 (516) provided the output device allows for such recording. If archiving is not desired go to step 8 (516).

(510) Step 5: The presenter 20 presses the archiving key 220 on the control panel 120. The internal archiving device is activated and records the presentation. Further pressing of archive key 220 toggles the recording function on and off.

(512) Step 6: Determine if the external image is to be annotated by the presenter 20. The presenter 20 can annotate the external image using the optical platen 104 of the multimedia hub 100. If annotation is not desired go to step 8 (516).

(514) Step 7: The presenter 20 presses the annotation key 218 on the control panel 120. The presenter 20 can write on the optical platen 104 using dry eraser markers or the like. The writing is recorded by the internal camera 108 and the video processing board 140 overlays the external image with the image received from the internal camera 108. The LCD monitor can be used during the step of annotating to allow the user the view the image received from the external input device.

(516) Step 8: The presentation is displayed on an output device or devices. It should be understood that step 2 (504), step 4 (508), and step 6 (512) can be invoked or revoked at any time during the presentation.

While this invention has been particularly shown and described with references to particular embodiments, it will be understood by those skilled in the art that various changes in form and details can be made without departing from the scope of the invention encompassed by the appended claims.

What is claimed is:

1. A multimedia hub apparatus comprising:
an optical platen having a first and a second surface;
an internal imager positioned below the second surface of the optical platen to image indicia on the first surface of the optical platen;
a converter for converting the image from the internal imager to a plurality of video formats; and
a plurality of outputs ports connected to the converter, each output port providing a respective video format.

2. The multimedia imaging and control apparatus as claimed in claim 1 further includes an integrated monitor connected to the converter.

3. The multimedia hub apparatus as claimed in claim 1 further includes a plurality of input ports connected to the converter for receiving image signals from a plurality of external input devices.

4. The multimedia hub apparatus as claimed in claim 3 wherein the plurality of input ports include a FireWire port, an ethernet port, a composite video signal port, a S-video port, a RGB port, a universal serial bus (USB) port, a microphone port and an audio port.

5. The multimedia hub apparatus as claimed in claim 3 wherein a user selects an input signal from a plurality of the input ports.

6. The multimedia hub apparatus as claimed in claim 5 wherein a controller includes an annotation mode to overlay an image derived from an input port with a user annotation formed on the first surface of the optical platen.

7. The multimedia hub apparatus as claimed in claim 3 further includes a recording device for archiving the images sent though the multimedia hub apparatus.

8. The multimedia hub apparatus as claimed in claim 1 wherein a mirror is positioned between the optical platen and the internal imager to reverse the image recorded by the internal imager.

9. The multimedia hub apparatus as claimed in claim 1 wherein the image recorded by the video imager is reversed by electronics housed with the hub.

10. The multimedia hub apparatus as claimed in claim 1 wherein the plurality of output ports include a FireWire port, an ethernet port, a composite video signal port, a S-video port, a RGB port, a universal serial bus (USB) port and an analog output port.

11. The multimedia hub apparatus as claimed in claim 1 wherein a controller allows a user to control the functions of the internal video imager.

12. The multimedia hub apparatus as claimed in claim 1 wherein the indicia include any writing, whether printed on paper, transparency film, or printed directly on the first surface of the optical platen.

13. A method of displaying a multimedia image comprising the steps of:
placing a writing on the first surface of an optical platen having a first and a second surface;
operating an internal imager below the second surface of the optical platen to generate an image representative of the writing on the first surface of the optical platen;
converting the image from the internal imager to a plurality of video formats; and
connecting an output device to one of a plurality of output ports for receiving a video signal representative of the image on the first surface of the optical platen.

14. The method as claimed in claim 13 further including viewing the output of the multimedia hub on an integrated monitor connected to the converter.

15. The method as claimed in claim 13 further including receiving image signals from a plurality of external input devices through a plurality of input ports connected to the converter.

16. The method as claimed in claim 15, wherein the plurality of input ports include a FireWire port, an ethernet port, a composite video signal port, a S-video port, a RGB port, a universal serial bus (USB) port, a microphone port and an audio port.

17. The method as claimed in claim 15 further allowing a user to select an input signal from a plurality of input ports.

18. The method as claimed in claim 17 further selecting an annotation mode to overlay an image derived from an input port with a user annotation formed on the first surface of the optical platen.

19. The method as claimed in claim 15 further includes archiving the images sent though the multimedia hub apparatus on a recording device.

20. The method as claimed in claim 13 further positioning a mirror between the optical platen and the imager to reverse the image seen by the imager.

21. The method as claimed in claim 13 further reversing the image recorded by the internal imager using electronics housed with the multimedia hub.

22. The method as claimed in claim 13, wherein the plurality of output ports include a FireWire port, an ethernet port, a composite video signal port, a S-video port, a RGB port, a universal serial bus (USB) port and an analog output port.

23. The method as claimed in claim 13 further allowing a user to control the functions of the internal imager using a controller.

24. The method as claimed in claim 13, wherein the indicia include any writing, whether printed on paper, transparency film, or printed directly on the first surface of the optical platen.

25. A multimedia hub apparatus comprising:
a optical platen having a first and a second surface;
an internal imager positioned below the second surface of the optical platen to provide a video signal representative of the image on the first surface of the optical platen;
a converter for converting the image from the internal imager to a plurality of video formats;
a plurality of output ports for connecting any of a plurality of output devices for receiving the video signal representative of the writing placed on the first surface of the optical platen, wherein the plurality of output ports include FireWire port, an ethernet port, a composite video signal port, a S-video port, a RGB port, a universal serial bus (USB) port and an analog output port;
a plurality of input ports for receiving image signals from any of a plurality of external input devices, wherein the plurality of input ports includes a FireWire port, an ethernet port, a composite video signal port, a S-video port, a RGB port, a universal serial bus (USB) port, a microphone port and an audio port;
a controller for allowing a user to control the operation of the multimedia hub; and
an annotation selector on the controller to select an annotation mode to overlay an image derived from an input port with a user annotation formed on the first surface of the optical platen.

26. The multimedia imaging and control apparatus as claimed in claim 25 further includes an integrated monitor connected to the converter.

27. The multimedia hub apparatus as claimed in claim 25 wherein a user selects an input signal from a plurality of the input ports.

28. The multimedia hub apparatus as claimed in claim 25 further includes a recording device for archiving the images sent though the multimedia hub apparatus.

29. The multimedia hub apparatus as claimed in claim 25 wherein a mirror is positioned between the optical platen and the internal imager to reverse the image recorded by the internal imager.

30. The multimedia hub apparatus as claimed in claim 25 wherein the image recorded by the video imager is reversed by electronics housed with the hub.

31. The multimedia hub apparatus as claimed in claim 25 wherein a controller allows a user to control the functions of the internal video imager.

32. The multimedia hub apparatus as claimed in claim 25 wherein the indicia include any writing, whether printed on paper, transparency film, or printed directly on the first surface of the optical platen.

33. A video communication apparatus comprising:
a first diffusing screen comprising a layer of a transparent material in contact with a layer of a diffusing material, the diffusing material having a first surface in contact with said transparent material and a second surface spaced from said transparent material by the thickness of the diffusing material, the second surface forming a receiving surface that is substantially smooth and of a quality for accepting indicia thereupon, the first surface of the diffusing material in contact with said transparent material forming a transmitting surface;
a video camera positioned to provide a first video signal representative of the indicia on the transmitting surface, the video camera separated from the second surface by the transparent material and the diffusing material, wherein the diffusing material is thin diffusing material bonded to one side of the transparent material, the thickness of the diffusing material being great enough to approximate the decoupling of a lambertian diffuser, but not so thick as to degrade the spatial resolution of the indicia;
a plurality of video output ports for connecting a plurality of external output devices for receiving a respective video signal representative of the indicia on the transmitting surface;
a plurality of video input ports for receiving video signals from a plurality of external input devices;
a converter electrically disposed between the internal video camera, the video input ports, and the video output ports to receive a video signal having video information and output the video information to the video output ports;
a controller for allowing a user to control the operation of the multimedia hub; and
an annotation selector on the controller to select an annotation mode to overlay an image derived from an input port with a user annotation formed on the first surface of the optical platen.

34. A multimedia hub apparatus comprising:
means for placing an image on an optical platen;
means for positioning an internal video camera to provide a video signal representative of the image on the optical platen;
means for connecting a plurality of external output devices for receiving the video signal representative of the image on the optical platen; and
means for allowing a user to control the operation of the multimedia hub.

35. A multimedia hub apparatus, comprising:
a video processor for processing video information in a base format;
a first input converter coupled to the video processor for converting a first video signal comprising first video information in a first input format to the base format; and
a plurality of output converters coupled to the video processor for converting the first video information from the base format to a plurality of output video signals, each output video signal in a respective format.
